(19) United States
(12) Patent Application Publication
(10) Pub. No.: US 2016/0069513 A1
(43) Pub. Date: Mar. 10, 2016

(54) Oil Filter Drain Tool

(71) Applicant: Stratus Tool Technologies, LLC, Newnan, GA (US)

(72) Inventor: Bobby Knoll, Borger, TX (US)

(21) Appl. No.: 14/479,685

(22) Filed: Sep. 8, 2014

(51) Int. Cl. F16N 31/00; F16L 55/24

(52) U.S. Cl. CPC F16N 31/00; F16L 55/24

(57) ABSTRACT

A fluid filter draining device is shown for draining fluid from a fluid container, such as an oil filter, in a controlled manner. An engagement collar is mounted on the outer sidewalls of a fluid filter. The engagement collar carries a threaded screw with a sharpened tip and a turning knob. When knob is turned, the screw tip penetrates the sidewall of the fluid filter and enters the fluid containing cavity of the filter. Fluid is drained through a channel formed by the drainage port and through an associated drainage hose to a collection container.

### BACKGROUND OF THE INVENTION

1. Field of the Invention

This invention relates generally to an apparatus for removing fluid from a container and more specifically to a device and method for draining hot fluid from, for example, an oil filter before the filter is removed from an associated motor or machinery, to avoid leakage or spillage of the fluid from the filter.

2. Description of the Prior Art

Lubrication systems in machinery, aircraft and vehicles include oil filters, which must be replaced periodically to maintain the good working order of the engine and machinery. For passenger automobiles, many mechanics recommend a oil and filter change every 3,000 miles of travel to maintain maximum engine life. Professional truckers put hundreds of thousands of miles on their trucks every year and as a result require frequent oil changes.

Replacing the oil in a motor vehicle typically involves placing a large oil drain basin under the oil pan, removing the drain plug, thereby allowing the oil to drain therein, followed by unscrewing the oil filter from the engine block. Due to the engine designs of most engines, it has been difficult to remove oil filters without spilling oil onto the frame of the vehicle or surrounding work area and, more importantly, onto the mechanics doing the work. Since many oil changes are conducted when the oil is very hot, this also poses a safety issue to mechanics.

There have been various attempts in the prior art to solve the problem presented by removing a hot oil filter from a vehicle or other type of machinery. For example, U.S. Pat. No. 7,297,282 to Suzumori et al., shows a complicated oil drain tool. The drain mechanism includes a cap which is engaged with a case and having a drain hole. A drain member in the form of a drain plug is detachably mounted to the cap from an outer side thereof, thereby closing the drain hole. A valve member is provided in an inner side of the cap, closing the drain hole, and a spring energizer acts to urge the valve member in a direction which closes the drain hole. When the drain member is detached from the cap, residual fluid is discharged by a tubular draining jig which is inserted within the drain hole.

An earlier device is described in U.S. Pat. No. 4,177,529 to Sikula, Jr., which shows an oil filter draining wrench which has a cylindrical housing with a center punch for punching and draining oil from an oil filter. The filter wrench is hammered onto the filter. An oil drain outlet is used to drain the oil from the housing which collects it. In the tight engine compartments of modern motor vehicles, there would not likely be enough room for a mechanic to place such a housing over the oil filter or to swing a hammer.

U.S. Pat. Nos. 4,776,431 and 4,865,156 to Poling both show oil change devices which utilize punches and vacuum chambers. The vacuum chambers are attached by suction to the oil filter, and the punches are driven into the filter's sidewalls, penetrating the filter. Oil is evacuated out of the filter, through the vacuum chamber, and out the evacuation tube.

U.S. Pat. No. 5,299,714 to Kilgore discloses what is said to be a self-sealing oil filter punch, which is driven into the metal housing of an oil filter, so the oil can be drained through the hollow center of the punch and out the oil filter. The sharp tip of the punch is pushed through the bottom of the oil filter, and the punch has a resilient washer for sealing the punch against the oil filter's housing. A spigot valve is located on the end of the Kilgore device to control the oil flow through the punch.

Applicant's own prior U.S. Pat. No. 8,002,002, issued Aug. 23, 2011, shows a fluid filter draining device having an engagement ring which is frictionally engaged on the outer sidewalls of a fluid filter. The engagement ring carries a threaded screw with a sharpened tip. A channel communicates between an opening at a forward end of the screw and a rear region of the threaded screw. When the screw is turned it penetrates the sidewall of the fluid container and enters the fluid containing cavity of the filter. Fluid is drained through the channel in the drill tip and out through an associated swivel hose connection and swivel hose to a collection container.

While the device shown in the previously described U.S. Pat. No. 8,002,002, represented an advance in the state of the art at the time, there remained room for simplifying and improving the design. The present invention represents such an improved design for a filter draining apparatus of the above type which is easy to use, simple in design, and which adequately prevents spilling hot oil onto a mechanic or onto the surrounding work area.

### SUMMARY OF THE INVENTION

The fluid filter draining device of the invention allows hot fluid to be removed from the filter in a controlled manner and is intended to be used with a fluid filter of the type having a filter body with cylindrical sidewalls defining a fluid filled interior region there between, such as an oil filter on a vehicle. The device includes a semi-arcuate engagement collar having an exterior sidewall and an interior sidewall defining an inner circumferential area which is selectively sized to engage a selected region on the filter body cylindrical sidewalls for positioning the engagement collar on the filter to be drained. The engagement collar also has a threaded access port which includes a longitudinal extent which extends generally perpendicular to the exterior sidewall of the engagement collar at one circumferential location thereon when the draining device is located on the filter sidewalls, and which also includes a normally downwardly extending drain portion.

The device also includes a threaded shaft of a given length defined between and inner extent and an outer extent. The threaded shaft terminates at one extent thereof in a sharpened drill tip. The threaded shaft is sized to be threadedly received within the longitudinal extent of the threaded access port of the engagement collar along at least a portion of the length thereof. The outer extent of the threaded shaft terminates in a turning knob, the knob having an inner face and an outer face separated by a predetermined thickness. The length of the sharpened drill tip and threaded shaft are selected to allow the drill tip to extend beyond the engagement collar interior sidewall when the threaded shaft is received within the longitudinal extent of the threaded access port, whereby turning the knob by hand causes the drill tip to advance through the longitudinal extent of the threaded access port of the engagement collar and into contact with the circumferential location on the filter body sidewalls to thereby penetrate the filter body sidewalls.

The downwardly extending drain portion of the access port receives a drainage hose. The drainage hose has a central bore which communicates through the access port to the interior of the filter when the drill tip has penetrated the filter sidewalls, whereby fluid drained from the filter can be drawn out through the drainage hose.

Preferably, the threaded access port longitudinal extent has a stepped internal diameter, the stepped internal diameter including a first, outer extent which is threaded and a second inner extent which is of relatively greater diameter and which is not threaded. The internal diameter of the non-threaded inner extent of the access port longitudinal extent is of sufficient size to allow fluid to flow around the threaded shaft and drill tip and out the downwardly extending drain portion to the drainage hose when the threaded shaft is threadedly received within the access port longitudinal extent and the drill tip has penetrated the filter sidewalls. The engagement collar and turning knob can conveniently be formed of a light weight plastic material, such as a suitable nylon material.

The previously described fluid filter draining device can also conveniently be used with a clamping assembly which holds the filter draining device on the filter sidewalls. For example, the clamping device can comprise at least one clamp ring which circumscribes the exterior sidewall of the semi-arcuate engagement collar when the collar is in place on the filter sidewalls. One exemplary clamp ring is an automotive double wire hose clamp.

The device of the invention can be used in draining fluid from fluid filters which are still positioned on machines and motors. For example, the fluid filter can be an oil filter adapted to be positioned on a motor. In the method of use of the device of the invention, the previously described engagement collar of the filter draining device is mounted on the cylindrical sidewalls of the filter to be drained. A drainage hose is attached to the downwardly extending drain portion of the access port. A user then turns the turning knob so that the drill tip penetrates the cylindrical sidewall of the fluid filter. This action allows hot fluid to be drained from the fluid filter through access port and through the attached drainage hose. The method can be used in draining fluid from fluid filters which are still positioned on machines and motors. For example, the fluid filter can be a cannister type oil filter adapted to be positioned on a motor.

Additional objects, features and advantages will be apparent from the written description which follows.

### BRIEF DESCRIPTION OF THE DRAWINGS

FIG. 1 is an exploded view of the engagement collar and turning knob of the device of the invention.

FIG. 1A is an exploded view of the threaded shaft and drill tip used with the turning knob, showing a course knurl pattern formed along a portion of the length of the drill tip body.

FIG. 2 is a side, partial cross sectional view of the device of the invention showing the threaded shaft received within the access port of the device.

FIG. 3 is a view similar to FIG. 2, but taken from the top of the device.

FIG. 4 is a perspective view of the device of the invention in place on an oil filter cannister, the drainage hose being shown broken at one point along its length.

### DETAILED DESCRIPTION OF THE INVENTION

The present invention provides an improved device for removing oil from an oil filter that meets the foregoing objectives. The invention described herein and the various features and advantageous details thereof are explained more fully with reference to the non-limiting examples which are illustrated in the accompanying drawing and detailed in the following description. Descriptions of well-known components and processes and manufacturing techniques are omitted so as to not unnecessarily obscure the workings of the invention. The examples used herein are intended merely to facilitate an understanding of ways in which the invention herein may be practiced and to further enable those of skill in the art to practice the invention. Accordingly, the examples should not be construed as limiting the scope of the claimed invention.

Turning first to FIG. 4, there is shown a perspective view of the device of the assembly of the invention 11 which is used for drawing fluid from a container 13. The container 13 shown in FIG. 4 is a conventional oil filter such as is used on vehicle motors and machinery. The devices of the invention can be used to drain any number of containers, such as drums, cans, filters or pipes, of any number of fluids, e.g. lubricants, coolants, inks, and other chemicals, but is preferably used to drain an oil filter. The oil filter 13 has generally cylindrical sidewalls 10 and an engagement end 12 with an engagement opening 14 for engaging a cooperating surface on the vehicle engine or other machinery. By “generally cylindrical” it will be appreciated that the canister sidewalls may have a slight taper from top to bottom, or be provided with longitudinal flutes, or the like. Such canisters are well known in the art and are commercially available from any number of sources.

The assembly 11 includes both an engagement collar 15 and some cooperating device for holding the engagement collar 15 on the filter cylindrical sidewalls. In the version of the invention shown in FIG. 4, the cooperating device is a clamp ring, most preferably an automotive double wire hose clamp 16. It should be understood, however, that other clamping devices could be utilized, such as, for example, plastic ties. The double wire hose clamp 16 has a pair of encircling wires 18, 20, which are connected at a screw assembly 22. Turning the screw 24 in the assembly tightens the wires 18, 20, about the filter sidewalls.

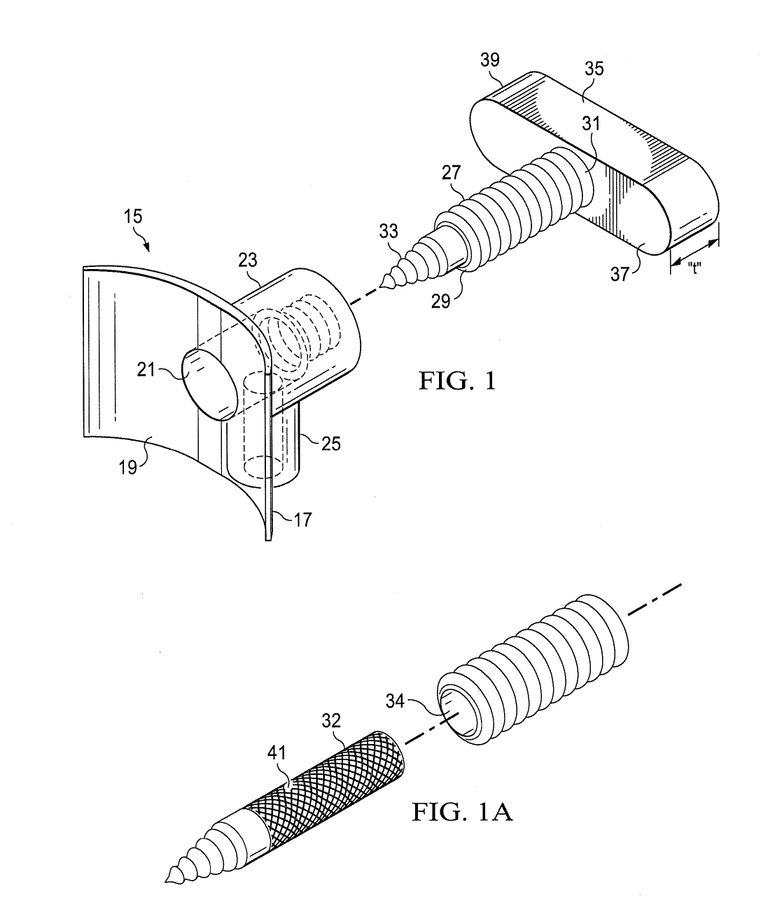

Turning now to FIG. 1, the engagement collar is shown in greater detail. The collar 15 can be formed of any convenient material including metals, plastics, composites, and the like. Preferably, the engagement collar is formed of a nylon plastic which is fiberglass filled. The engagement collar 15 is semi-arcuate in shape having an exterior sidewall 17 and an interior sidewall 19 defining an inner circumferential area which is selectively sized to engage a selected region on the filter body cylindrical sidewalls for positioning the engagement collar on the filter to be drained (as illustrated in FIG. 4).

The engagement collar also has a threaded access port (21 in FIG. 1) which includes a longitudinal extent 23 which extends generally perpendicular to the exterior sidewall of the engagement collar at one circumferential location thereon when the draining device is located on the filter sidewalls, and which also includes a normally downwardly extending cylindrical drain portion 25.

As will also be appreciated from FIGS. 1-3, the filter draining device of the invention also includes a threaded shaft 27 of a given length defined between and inner extent 29 and an outer extent 31. The threaded shaft 27 terminates at the inner extent thereof in a sharpened drill tip 33. The threaded shaft 27 is sized to be threadedly received within the longitudinal extent 23 of the threaded access port 21 of the engagement collar 15.

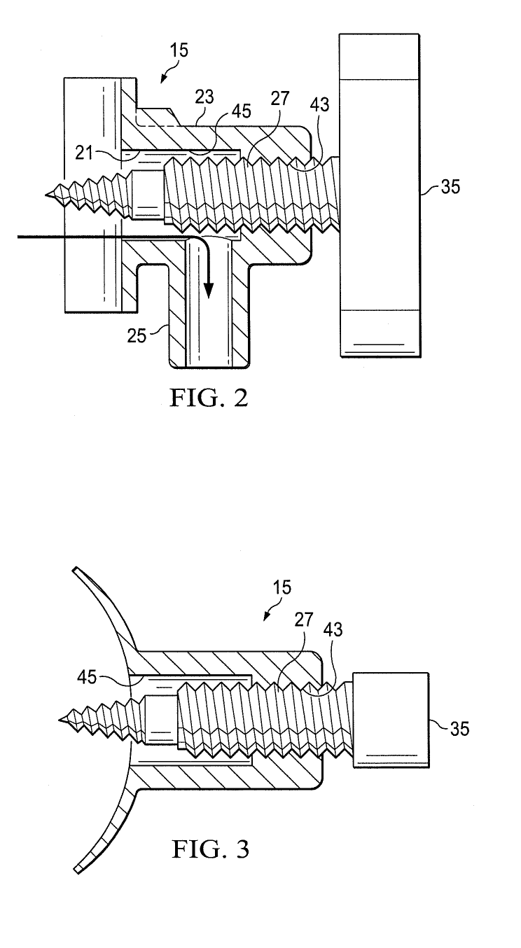

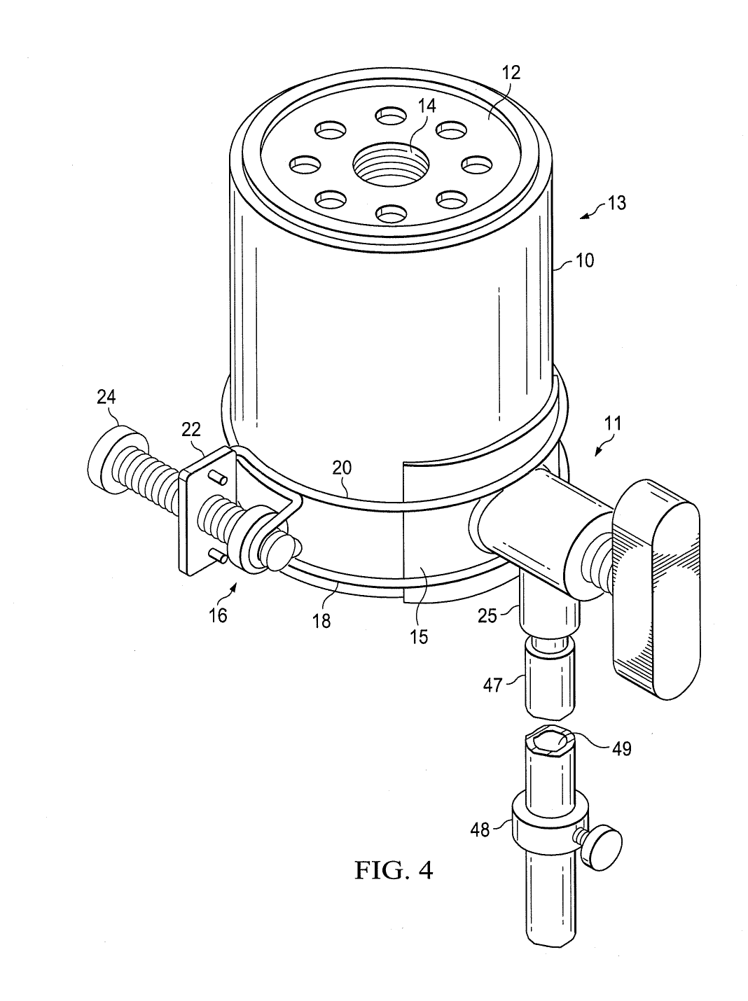

The outer extent 31 of the threaded shaft 27 terminates in a turning knob 35, the knob having an inner face 37 and an outer face 39 separated by a predetermined thickness “t.” The length of the sharpened drill tip 33 and threaded shaft 27 are selected to allow the drill tip 33 to extend beyond the engagement collar interior sidewall 19 (as in FIGS. 2 and 3) when the threaded shaft is received within the longitudinal extent of the threaded access port 21, whereby turning the knob 35 by hand causes the drill tip 33 to advance through the longitudinal extent of the threaded access port of the engagement collar and into contact with the circumferential location on the filter body sidewalls 10 to thereby penetrate the filter body sidewalls.

In one preferred form of the invention, the drill tip 33 is a standard screw thread 11 TPI, tapered to a sharp point. The thread length of the drill tip 33, in one exemplary example, is on the order of 0.520 inches. For this size tip, the threaded shaft length can be about 1.250 inches. As shown in FIG. 1A, the drill tip has a body portion 32 which, in this case, is machined from ⅜ inch bar stock of a convenient metal. In the version of the invention shown in FIGS. 1-3, the drill tip body portion 32 is threaded with a “course knurl” pattern (shown at 41 in FIG. 1A). By “knurl” is meant one of a series of small ridges or grooves on the surface or edge of a metal object, generally to aid in gripping. Knurling can be conducted, for example, on a lathe, where a diamond-shaped or criss-cross pattern in cut or rolled into the metal. Knurling can be used in many applications, for example, when a high precision component will be assembled into a low precision component, for example a metal pin into a plastic molding. The outer surface of the metal pin is knurled so that the raised detail ‘bites’ into the plastic irrespective of whether the size of the hole in the plastic closely matches the diameter of the pin. The knurl style is non-critical, but should be of a relatively course pattern by nature.

The drill tip body portion 32 can be forced into an interior bore 34 of the threaded shaft 27. The threaded shaft 27 can conveniently be formed of a plastic, such as nylon, so that the drill tip body portion 32 is then retained in the bore 34 by frictional engagement of the harder metal material and the relatively softer nylon material.

As can perhaps best be seen in FIG. 2, the longitudinal extent 23 of the threaded access port 21 has a stepped internal diameter. The stepped internal diameter includes a first, outer extent 43 which is threaded and a second, inner extent 45 which is of relatively greater diameter and which is not threaded. It will be appreciated that the internal diameter of the non-threaded inner extent 45 of the access port longitudinal extent 23 is of sufficient size to allow fluid to flow around the threaded shaft 27 and out the downwardly extending drain portion 25 when the threaded shaft is threadedly received within the access port longitudinal extent (as indicated by the arrow in FIG. 2).

As can be seen in FIG. 4, the downwardly extending drain portion 25 of the access port 21 as a generally cylindrical exterior surface which is adapted to receive one end of a drainage hose 47. The drainage hose can be positioned on the hose end by means of a simple clamp 48 or by other convenient means. The drainage hose has a central bore 49 which communicates through the access port to the interior of the filter when the drill tip 33 has penetrated the filter sidewalls, whereby fluid drained from the filter can be drawn out through the drainage hose. The drainage hose 47, which is typically supplied as an option by the customer, can also be provided with an on-off valve (not shown), if desired, to control the flow of fluid through the hose.

In operation, the engagement collar 15 is positioned about the cylindrical sidewalls of the filter cannister with the turning knob 35 and associated drill bit tip 25 assembled. The operator then turns the knob 35, driving the drill bit tip 33 into the cannister sidewall until the sidewall has been pierced and the drill tip has entered the cannister interior. Hot oil can then flow through the relatively larger diameter of the inner extent 45 of the longitudinal extent of the access port and out through the downwardly extending drain portion 25 of the access port to the drainage hose 47 to a collection container. If desired, a vacuum can be applied through the drainage hose to assist in the flow of hot oil. Once the filter cannister has been drained of oil, the filter can be unscrewed and safely removed.

An invention has been provided with several advantages. The device is simple in design and economical to manufacture. The device safely removes hot oil from an oil filter cannister, so that the danger of hot oil being spilled during the subsequent filter removal is eliminated. The device provides an easy, fast and secure method of draining hot oil from a filter while the filter is in place on a vehicle motor or other piece of machinery.

While the invention has been shown in only one of its forms, it is not thus limited but is susceptible to various changes and modifications without departing from the spirit thereof, as described in the claims which follow.

What is claimed is:

1. A fluid filter draining device which allows hot fluid to be removed from the filter in a controlled manner, the fluid filter having a filter body with cylindrical sidewalls defining a fluid filled interior region there between, the fluid filter draining device comprising:
a semi-arcuate engagement collar having an exterior sidewall and an interior sidewall defining an inner circumferential area which is selectively sized to engage a selected region on the filter body cylindrical sidewalls for positioning the engagement collar on the filter to be drained, the engagement collar also having a threaded access port which includes a longitudinal extent which extends generally perpendicular to the exterior sidewall of the engagement collar at one circumferential location thereon when the draining device is located on the filter sidewalls, and which also includes a normally downwardly extending drain portion;
a threaded shaft of a given length defined between and inner extent and an outer extent, the threaded shaft terminating at one extent thereof in a sharpened drill tip, the threaded shaft being sized to be threadedly received within the longitudinal extent of the threaded access port of the engagement collar along a portion of a length thereof;
wherein the outer extent of the threaded shaft terminates in a turning knob, the knob having an inner face and an outer face separated by a predetermined thickness, the length of the sharpened drill tip and threaded shaft being selected to allow the drill tip to extend beyond the engagement collar interior sidewall when the threaded shaft is received within the longitudinal extent of the threaded access port, whereby turning the knob by hand causes the drill tip to advance through the longitudinal extent of the threaded access port of the engagement collar and into contact with the circumferential location on the filter body sidewalls to thereby penetrate the filter body sidewalls; and
wherein the downwardly extending drain portion of the access port receives a drainage hose, the drainage hose having a central bore which communicates through the access port to the interior of the filter when the drill tip has penetrated the filter sidewalls, whereby fluid drained from the filter can be drawn out through the drainage hose.

2. The fluid filter draining device of claim 1, wherein the threaded access port longitudinal extent has a stepped internal diameter, the stepped internal diameter including a first, outer extent which is threaded and a second inner extent which is of relatively greater diameter than the diameter of the first outer extent.

3. The fluid filter draining device of claim 2, wherein the internal diameter of the second, inner extent of the access port longitudinal extent is of sufficient size to allow fluid to flow around the sharpened drill tip and out the downwardly extending drain portion to the drainage hose when the threaded shaft is threadedly received within the access port longitudinal extent.

4. The fluid filter drainage device of claim 3, wherein the sharpened drill tip has a metal body portion with an exterior surface which is threaded in a course knurl pattern, the metal body portion being received within an internal bore of the threaded shaft in a frictional fit.

5. The fluid filter drainage device of claim 4, wherein the engagement collar, turning knob and threaded shaft are formed of a light weight plastic material.

6. The fluid filter drainage device of claim 5, wherein the engagement collar, turning knob and threaded shaft are formed of a nylon material.

7. In combination, a fluid filter draining device and clamping assembly which allows hot fluid to be removed from the filter in a controlled manner, the fluid filter having a filter body with cylindrical sidewalls defining a fluid filled interior region there between, the combination comprising:
a semi-arcuate engagement collar having an exterior sidewall and an interior sidewall defining an inner circumferential area which is selectively sized to engage a selected region on the filter body cylindrical sidewalls for positioning the engagement collar on the filter to be drained, the engagement collar also having a threaded access port which includes a longitudinal extent which extends generally perpendicular to the exterior sidewall of the engagement collar at one circumferential location thereon when the draining device is located on the filter sidewalls, and which also includes a normally downwardly extending drain portion;
a threaded shaft of a given length defined between and inner extent and an outer extent, the threaded shaft terminating at one extent thereof in a sharpened drill tip, the threaded shaft being sized to be threadedly received within the longitudinal extent of the threaded access port of the engagement collar;
wherein the outer extend of the threaded shaft terminates in a turning knob, the knob having an inner face and an outer face separated by a predetermined thickness, the length of the sharpened drill tip and threaded shaft being selected to allow the drill tip to extend beyond the engagement collar interior sidewall when the threaded shaft is received within the longitudinal extent of the threaded access port, whereby turning the knob by hand causes the drill tip to advance through the longitudinal extent of the threaded access port of the engagement collar and into contact with the circumferential location on the filter body sidewalls to thereby penetrate the filter body sidewalls;
wherein the downwardly extending drain portion of the access port receives a drainage hose, the drainage hose having a central bore which communicates through the access port to the interior of the filter when the drill tip has penetrated the filter sidewalls, whereby fluid drained from the filter can be drawn out through the drainage hose; and
at least one clamp ring which circumscribes exterior sidewall of the semi-arcuate engagement collar when the collar is in place on the filter sidewalls.

8. The combination of claim 7, wherein the clamp ring is an automotive double wire hose clamp.

9. The combination of claim 8, wherein the device is adapted for use in draining fluid from fluid filters which are still positioned on machines and motors.

10. The combination of claim 9, wherein the fluid container is an oil filter adapted to be positioned on a motor.

11. A method of draining hot fluid from a fluid filter in a controlled manner, the fluid filter having a filter body with cylindrical sidewalls defining a fluid filled interior region there between, the method comprising the steps of:
providing a semi-arcuate engagement collar having an exterior sidewall and an interior sidewall defining an inner circumferential area which is selectively sized to engage a selected region on the filter body cylindrical sidewalls for positioning the engagement collar on the filter to be drained, the engagement collar also having a threaded access port which includes a longitudinal extent which extends generally perpendicular to the exterior sidewall of the engagement collar at one circumferential location thereon when the draining device is located on the filter sidewalls, and which also includes a normally downwardly extending drain portion;
providing a threaded shaft of a given length defined between and inner extent and an outer extent, the threaded shaft terminating at one extent thereof in a sharpened drill tip, the threaded shaft being sized to be threadedly received within the longitudinal extent of the threaded access port of the engagement collar along at least a portion of a length thereof;
wherein the outer extend of the threaded shaft terminates in a turning knob, the knob having an inner face and an outer face separated by a predetermined thickness, the length of the sharpened drill tip and threaded shaft being selected to allow the drill tip to extend beyond the engagement collar interior sidewall when the threaded shaft is received within the longitudinal extent of the threaded access port, whereby turning the knob by hand causes the drill tip to advance through the longitudinal extent of the threaded access port of the engagement collar and into contact with the circumferential location on the filter body sidewalls to thereby penetrate the filter body sidewalls;
wherein the downwardly extending drain portion of the access port receives a drainage hose, the drainage hose having a central bore which communicates through the access port to the interior of the filter when the drill tip has penetrated the filter sidewalls, whereby fluid drained from the filter can be drawn out through the drainage hose;
mounting the engagement collar on the cylindrical sidewall of the filter;
attaching a drainage hose to the downwardly extending drain portion of the access port;
turning the turning knob so that the drill tip penetrates the cylindrical sidewall of the fluid filter; and
draining off hot fluid from the fluid filter through access port and through the attached drainage hose.

12. The method of claim 11, wherein the method is used in draining fluid from fluid filters which are still positioned on machines and motors.

13. The method of claim 12, wherein the fluid filter is a canister type oil filter adapted to be positioned on a motor.
